(19) United States
(12) Patent Application Publication
(10) Pub. No.: US 2020/0184664 A1
(43) Pub. Date: Jun. 11, 2020

(54) ELECTRONIC DEVICE AND METHOD FOR ACQUIRING DEPTH INFORMATION OF OBJECT BY USING THE SAME

(71) Applicant: Samsung Electronics Co., Ltd., Gyeonggi-do (KR)

(72) Inventors: Dongho RHEE, Gyeonggi-do (KR); Seoungmyoung KIM, Gyeonggi-do (KR); Jeonggyun PARK, Gyeonggi-do (KR); Sangpil LEE, Gyeonggi-do (KR); Soobum LEE, Gyeonggi-do (KR); Dongkeun JUNG, Gyeonggi-do (KR)

(21) Appl. No.: 16/577,204

(22) Filed: Sep. 20, 2019

(30) Foreign Application Priority Data
Dec. 6, 2018 (KR) 10-2018-0156256

(51) Int. Cl. G06T 7/536; G01B 11/02; H01J 49/40; H04N 13/271; G01S 17/89; H04N 5/225

(52) U.S. Cl. CPC G06T 7/536; G01B 11/026; H01J 49/406; G06T 2207/10028; G01S 17/89; H04N 5/2256; H04N 13/271

(57) ABSTRACT

An electronic device is disclosed herein. The electronic device includes an illuminator configured to output light of a first designated wavelength band, a time of flight (ToF) sensor configured to acquire the light of the first designated wavelength band, an optical sensor configured to acquire light of a second designated wavelength band, and a processor, configured to: measure, through the optical sensor, a light quantity of an environment in which the electronic device is disposed, determine a first power amount to be supplied to the illuminator, based on the measured light quantity, control the illuminator to irradiate light of a first intensity toward an object, using a supply of power to the illuminator at the first power amount, detect, by the ToF sensor, at least a part of the irradiated light, when reflected off the object and back towards the electronic device, and generate depth information for the object using the at least the part of the detected irradiated light reflected off the object.

### CROSS-REFERENCE TO RELATED APPLICATION(S)

This application is based on and claims priority under 35 U.S.C. § 119 to Korean Patent Application No. 10-2018-0156256, filed on Dec. 6, 2018, in the Korean Intellectual Property Office, the disclosure of which is incorporated by reference herein in its entirety.

### BACKGROUND

### Technical Field

The disclosure relates to an electronic device including a time-of-flight (ToF) sensor and, more particularly, to acquiring depth information of an object using the electronic device using the ToF sensor.

### Background

Recently, there has been an increase in interest and research into 3D cameras, motion sensors, and laser radars (LADAR), which can acquire distance information to an object. In particular, with the development and increased demand for 3D display devices capable of displaying images with simulated depth, 3D content has grown in importance. Accordingly, there has been study into various depth-sensitive image acquisition devices enabling a general user to directly produce 3D content.

Depth information for an object may be acquired using a stereo vision method, involving two cameras, or a triangulation method using structured light and a camera. However, such methods have drawbacks in that it may be difficult to acquire accurate depth information because accuracy abruptly deteriorates as the distance between the object and an electronic device increases. Further, the effectiveness of the method can be negatively affected by the surface state of the object.

Recently, a depth information acquisition method using a time of flight (ToF) has been developed. The ToF method measures a time period during which illumination light is irradiated onto an object and then reflected from the object, and then received/detected through a light receiver. According to ToF technology, light of a specific wavelength band (e.g., near-infrared ray of 950 nm) is irradiated onto the object using an illuminator via light-emitting diodes (LED) or laser diodes (LD). Subsequently, light of the same wavelength band is reflected from the object and acquired by a ToF sensor, and then a series of processes for acquiring depth information of the object are performed.

### SUMMARY

Using ToF technology, depth information for an object is acquired using an infrared light source, and thus it may show a characteristic that is sensitive to light. For example, in a specific environment, accuracy of the depth information may abruptly deteriorate.

More specifically, in an indoor environment having relatively low infrared noise, depth information for the object can be acquired accurately and with some stability. However, in an outdoor environment in which there is a preponderance of infrared noise, it may be difficult to acquire an estimation of the depth information with high quality and accuracy.

Further, if high power is continuously supplied to an illuminator to compensate for an environmental noise, a large amount of power may be unnecessarily wasted.

An electronic device and a method for acquiring depth information of an object using the same according to certain embodiments of the disclosure can provide a method capable of acquiring an optimum depth image through adjustment of the light intensity and a modulation type to suit an environment.

An electronic device and a method for acquiring depth information of an object using the same according to certain embodiments of the disclosure can reduce power consumption through supply of a power utilized to acquire a depth image to an illuminator.

According to certain embodiments of the disclosure, an electronic device may include an illuminator configured to output light of a first designated wavelength band, a time of flight (ToF) sensor configured to acquire the light of the first designated wavelength band, an optical sensor configured to acquire light of a second designated wavelength band, and a processor, configured to: measure, through the optical sensor, a light quantity of an environment in which the electronic device is disposed, determine a first power amount to be supplied to the illuminator, based on the measured light quantity, control the illuminator to irradiate light of a first intensity toward an object, using a supply of power to the illuminator at the first power amount, detect, by the ToF sensor, at least a part of the irradiated light, when reflected off the object and back towards the electronic device, and generate depth information for the object using the at least the part of the detected irradiated light reflected off the object. According to certain embodiments of the disclosure, an electronic device may include an illuminator configured to output light of a first designated wavelength band, a time of flight (ToF) sensor configured to acquire the light of the first designated wavelength band, an optical sensor configured to acquire light of a second designated wavelength band, a processor, configured to: measure, through the optical sensor, a light quantity for an environment in which the electronic device is disposed, control the illuminator to irradiate light of a first intensity toward an object based on a designated power amount determined based on the measured light quantity, acquire at least a part of the irradiated light after the irradiated light is reflected by the object back towards the electronic device through the ToF sensor, identify a distance between the object and the electronic device based at least on the acquired part of the irradiated light, determine at least one of a power amount to supply to the illuminator, and a modulation frequency of the illuminator, based on the light quantity of the environment and the identified distance between the object and the electronic device, and acquire depth information for the object. According to certain embodiments of the disclosure, an electronic device may include an illuminator configured to output light of a first designated wavelength band, a time of flight (ToF) sensor configured to acquire the light of the first designated wavelength band, a processor, configured to: measure a light quantity of an environment in which the electronic device is disposed through the ToF sensor, determine a first power amount to be supplied to the illuminator based on the measured light quantity, control the illuminator to irradiate light of a first intensity toward an object using a supply of power to the illuminator at the first power amount, acquire at least a part of the irradiated light when reflected by the object back towards the electronic device through the ToF sensor, and acquire depth information for the object using the acquired part of the irradiated light. The electronic device and the method for acquiring the depth information of the object using the same according to certain embodiments of the disclosure can acquire the depth information of the high quality and can reduce the power consumption at the same time.

### BRIEF DESCRIPTION OF THE DRAWINGS

FIG. 1 is a block diagram of an electronic device 101 in a network environment 100 according to certain embodiments;

FIG. 2 is a block diagram of an electronic device 101 according to certain embodiments;

FIG. 3 is a flowchart illustrating a method for acquiring depth information according to certain embodiments of the disclosure;

FIG. 4 is a flowchart illustrating a method for acquiring depth information according to certain embodiments of the disclosure;

FIG. 5 is a flowchart illustrating a method for acquiring depth information according to certain embodiments of the disclosure;

FIG. 6 is a flowchart illustrating a method for acquiring depth information according to certain embodiments of the disclosure;

FIG. 7 is a flowchart illustrating a method for acquiring depth information according to certain embodiments of the disclosure; and

FIG. 8 is a diagram illustrating an example of adjusting a set value based on a surrounding environmental condition of an electronic device 101 according to an embodiment of the disclosure.

### DETAILED DESCRIPTION

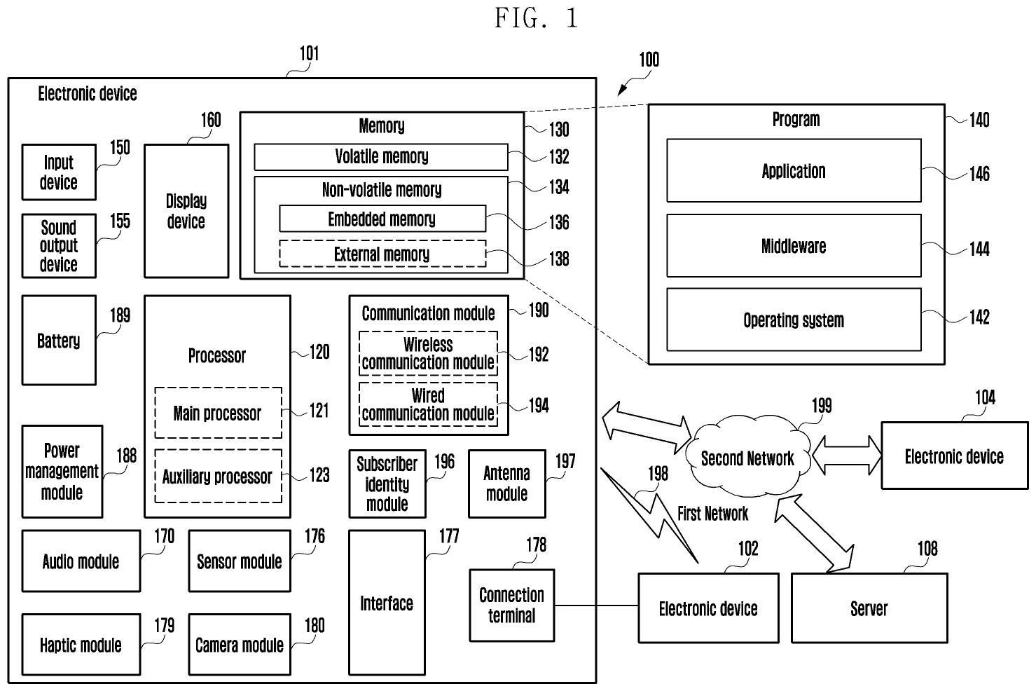

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element implemented using a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

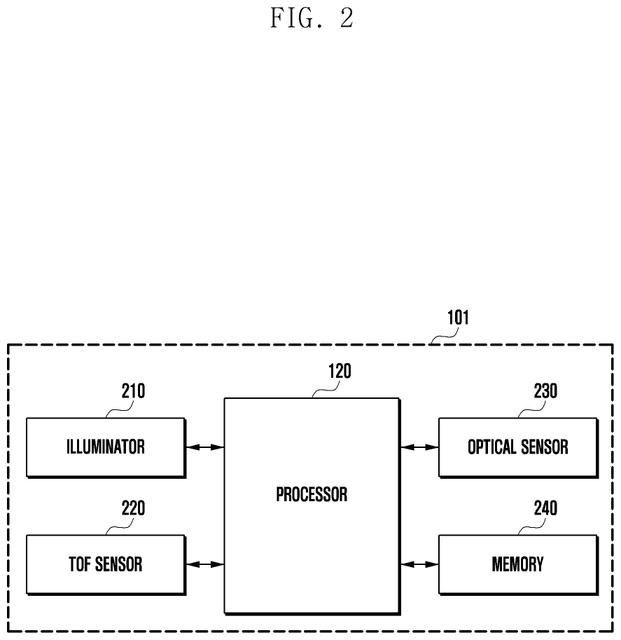

FIG. 2 is a block diagram of an electronic device 101 according to certain embodiments.

According to certain embodiments, an electronic device 101 may include a processor 120, an illuminator 210, a time of flight (ToF) sensor, an optical sensor 230, and a memory 240 (e.g., memory 130 of FIG. 1). In a certain embodiment, the electronic device 101 may omit at least one of the above-described constituent elements, or it may be additionally provided with other constituent elements.

The processor 120 according to certain embodiments may include one or more of a central processing unit, an application processor, or a communication processor (CP). For example, the processor 120 may execute an operation or a data process for control and/or communication of at least one of the other constituent elements of the electronic device 101.

The illuminator 210 according to certain embodiments may include at least one light source of a light-emitting diode (LED), a laser diode (LD) or a laser light source. The illuminator 210 according to an embodiment may include a plurality of light sources capable of outputting light within a first designated wavelength band. The first designated wavelength band, according to an embodiment, may be a wavelength band that is invisible to the human eye. For example, it may be a wavelength of a near-infrared (NIR) region of 800 nm to 1000 nm. However, the first designated wavelength band is not limited thereto, but it may include light of a wavelength band that is visible to the human eye (e.g., visible light ray). The illuminator 210, according to an embodiment, may output a modulation light modulating in a high frequency pulse shape, in accordance with a designated modulation frequency value. For example, the illuminator 210 may sporadically output light which blinks at designated time intervals.

The illuminator 210 according to certain embodiments may include a driver (e.g., laser diode controller) capable of driving the light source based on a driving signal received from the processor 120. For example, the driver may operate the light source by applying a power (e.g., driving voltage) to the light source. In accordance with the level of the power being applied by the driver, the intensity and/or the wavelength of the light being irradiated by the light source may be changed. For example, as the level of the driving voltage being applied to the light source becomes higher, the level of the light being outputted from the light source may be stronger.

The ToF sensor 220 according to certain embodiments may include an image capturing device capable of acquiring light of a first designated wavelength band. If it is intended to measure a distance to any one point of an object, the image capturing device may include, for example, one photodiode or one pyroelectric detector. However, if it is intended to simultaneously measure distances to a plurality of points on the object, the image pickup device may be configured to include photodiodes and/or pyroelectric detectors for a plurality of cells arranged in a 2D and/or 1D array. According to an embodiment, a plurality of photodiodes and/or pyroelectric detectors may be included in one cell. The image pickup capturing device according to an embodiment may be configured to measure the intensity of the received light.

The ToF sensor 220 according to certain embodiments may include a calculation module calculating depth information. The calculation module may calculate a phase difference between light reflected from the object and light irradiated by the illuminator 210 using, for example, the intensity of light measured by the image capturing device. The calculation module according to an embodiment may calculate the distance between the electronic device 101 and the object using the phase difference.

The ToF sensor 220 according to certain embodiments may be synchronized with the same modulation frequency value as that of the illuminator 210. For example, by synchronizing the ToF sensor 220 and the illuminator 210 with the same modulation frequency value, the processor 120 may identify the phase difference between the light irradiated from the illuminator 210 and the light acquired by the ToF sensor 220.

The optical sensor 230 according to certain embodiments is a device measuring the intensity of light, and it may be configured by various sensors capable of changing an incident amount of photons to current. For example, the optical sensor 230 may include at least one of an illumination sensor or an image sensor. The processor 120 according to an embodiment may acquire an illumination value around the electronic device 101, and it may determine the light quantity based on the acquired illumination value. Further, in a certain embodiment, the processor 120 may acquire image data around the electronic device 101, and it may determine the light quantity around the electronic device 101 through analysis of the acquired image data.

The memory according to certain embodiments may store therein one or more programs executed by the processor 120, and it may perform a function of temporarily storing input/output data. The input/output data may include instructions for controlling, for example, the illuminator 210, the ToF sensor 220, and the optical sensor 230.

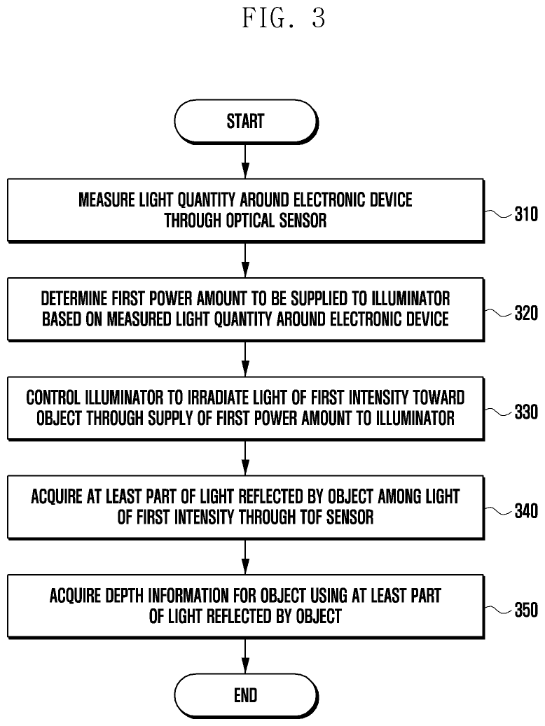

FIG. 3 is a flowchart illustrating a method for acquiring depth information according to certain embodiments of the disclosure. Depth may include 3D topology of the object in question, which may allow the device to generate 3D modeling/data for the object based on the detection operations and devices indicated herein.

With reference to FIG. 3, at operation 310, the processor 120 of the electronic device 101 may measure a light quantity of an environment in which the electronic device 101 is disposed, through the optical sensor 230.

The processor 120 according to certain embodiments may acquire the illumination value for the environment of the electronic device 101 using the optical sensor 230, and it may measure the light quantity based on the acquired illumination value. Further, in a certain embodiment, the processor 120 may acquire image data of the environment of the electronic device 101 using the optical sensor 230, and measure the light quantity through analysis of the acquired image data.

According to certain embodiments, if a light receiver (e.g., photodiode or image pixel) of the optical sensor 230 changes the acquired light energy to electric energy, the processor 120 may measure the light quantity based on the acquired electric energy. For example, the electric energy may be indicated as a specific level in the range of 0 to 100 levels. The respective levels may correspond to specific light quantities. For example, level 50 may correspond to the light quantity of 700 nit or 700 lux.

At operation 320, the processor 120 of the electronic device 101 may determine a first power amount to be supplied to the illuminator 210 based on the measured light quantity around the electronic device 101.

The processor 120 according to certain embodiments may control the illuminator 210 to output light by applying power (e.g., driving voltage) to the illuminator 210. In accordance with the level of the power being applied by the processor 120, the intensity and/or the wavelength of the light irradiated by the illuminator 210 may be altered. For example, the processor 120 may determine the specific first power amount to be supplied to the illuminator 210 according to whether the light quantity around the electronic device 101 satisfies a predesignated condition. For example, if the light quantity is smaller than a first threshold value (e.g., if the light quantity is lower than the level 50), the processor 120 may apply a power of 1 W to the illuminator 210. As another example, if the light quantity is equal to or larger than the first threshold value (e.g., if the light quantity is equal to or higher than the level 50), the processor 120 may apply the power of 3 W to the illuminator 210.

The illuminator 210 according to certain embodiments may include the driver (e.g., laser diode controller) capable of driving the light source based on a driving signal received from the processor 120. In this case, the processor 120 may transfer another driving signal to the driver depending on whether the light quantity around the electronic device 101 satisfies the designated condition. For example, if the light quantity satisfies the designated condition (e.g., if the light quantity is equal to or lower than the level 50), the processor 120 may transfer a driving voltage corresponding to the power of 1 W to the driver, whereas if the light quantity does not satisfy the designated condition (e.g., if the light quantity exceeds the level 50), the processor 120 may transfer the driving voltage corresponding to the power of 3 W to the driver.

The processor 120 according to certain embodiments may determine location information of the electronic device 101 at least partly based on the light quantity around the electronic device 101. For example, the processor 120 may determine whether the electronic device 101 is located indoors or outdoors based on the surrounding brightness level. In this case, the electronic device 101 may identify reliability of the determined location information using at least one other sensor and/or application. For example, the processor 120 may identify the reliability of the location information using a GPS sensor and a map application.

The processor 120 according to certain embodiments may determine a second power amount to be supplied to the illuminator 210 so that the illuminator 210 irradiates light of a second intensity in accordance with the location information of the electronic device 101. For example, in the room where a fluorescent lamp exists, illumination may be high, but infrared noise may be low. Accordingly, the processor 120 may supply the second power amount that is smaller than the first power amount to the illuminator 210. In contrast, at the outside, infrared noise caused by sunlight may be high, and thus the processor 120 may supply the second power amount that is larger than the first power amount to the illuminator 210.

At operation 330, the processor 120 of the electronic device 101 may control the illuminator 210 to irradiate light of the first intensity toward the object, through a supply of the first power amount to the illuminator 210. Here, the object may indicate an object for which there is an intent to acquire the depth information. Further, the first intensity may correspond to, for example, the first power amount being supplied from the processor 120.

At operation 340, the processor 120 of the electronic device 101 may acquire at least a part of the light of the first intensity when it is reflected back towards the ToF sensor 220, as to be detected through the ToF sensor 220.

The processor 120, according to certain embodiments, may measure the intensity of the light reflected from the object and detected (and measured) by the ToF sensor 220. The processor 120 may calculate a phase difference between the light reflected from the object and the light irradiated by the illuminator 210 using the intensity of the light measured by the ToF sensor 220.

At operation 350, the processor 120 of the electronic device 101 may acquire the depth information of the object using at least a part of the light reflected by the object.

For example, the processor 120 may simultaneously measure distances to a plurality of points on the object, based on the phase difference between the light reflected from the object and the light irradiated by the illuminator 210. The processor 120, according to an embodiment, may measure the distances to the plurality of points on the object, and it may generate a depth image for the object.

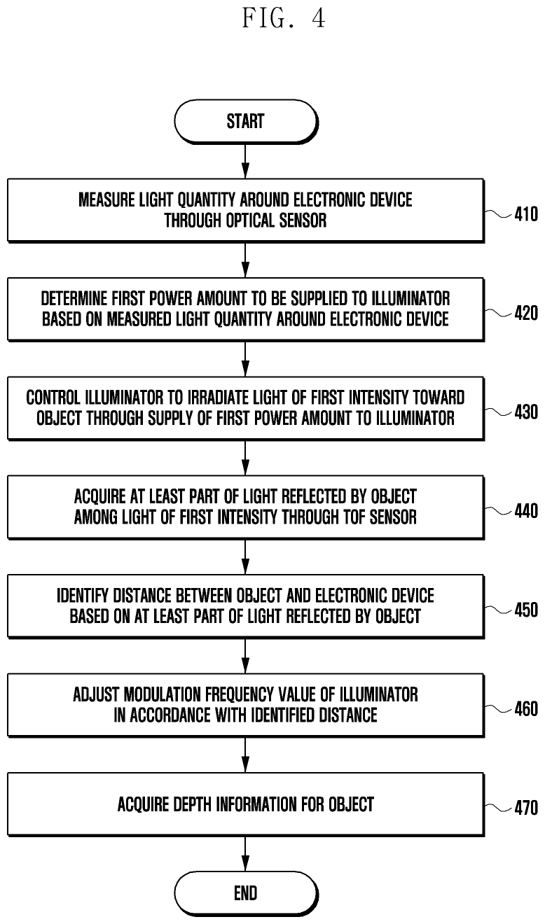

FIG. 4 is a flowchart illustrating a method for acquiring depth information according to certain embodiments of the disclosure.

With reference to FIG. 4, at operation 410, the processor 120 of the electronic device 101 may measure the light quantity in an environment of the electronic device 101 through the optical sensor 230.

At operation 420, the processor 120 of the electronic device 101 may determine the first power amount to be supplied to the illuminator 210 based on the measured light quantity of the environment of the electronic device 101.

At operation 430, the processor 120 of the electronic device 101 may control the illuminator 210 to irradiate the light of the first intensity toward the object through supply of the first power amount to the illuminator 210.

At operation 440, the processor 120 of the electronic device 101 may acquire at least a part of the light of the first intensity through the ToF sensor 220, when the light is reflected back towards the ToF sensor 220 from the object.

At operation 450, the processor 120 of the electronic device 101 may identify the distance between the object and the electronic device 101 based on at least a part of the light reflected by the object.

According to certain embodiments, the processor 120 may identify the distance between the object and the electronic device 101 through calculation of the time of flight of the difference between the time when the illuminator 210 irradiates the light and the time when the ToF sensor 220 receives the light. The processor 120 according to an embodiment may designate one certain point on the object, and it may determine the distance to the one certain point as the distance between the object and the electronic device 101. This is to identify the rough distance between the electronic device 101 and the object before the depth image for the object is acquired.

At operation 460, the processor 120 of the electronic device 101 may adjust a modulation frequency value of the illuminator 210 in accordance with the identified distance.

The illuminator 210 according to certain embodiments may output a modulated light for modulating the light in a high frequency pulse shape in accordance with the designated modulation frequency value. For example, the illuminator 210 may irradiate lights having phases of 0°, 90°, 180°, and 270° onto the object. In this case, the illuminator 210 may output the light which “blinks” (e.g., activates, deactivates and reactivates) at designated time intervals.

The processor 120 according to certain embodiments may set another modulation value depending on whether the distance between the electronic device 101 and the object satisfies the designated condition. For example, if the distance between the electronic device 101 and the object satisfies the designated condition (e.g., 3 M or less), the processor 120 may set the modulation frequency to a specific frequency value within 50 MHz to 200 MHz. Further, if the distance between the electronic device 101 and the object does not satisfy the designated condition (e.g., exceeding 3 M), the processor 120 may set the modulation frequency value to a specific frequency value within 25 MHz to 50 MHz.

The processor 120 according to certain embodiments may synchronize the illuminator 210 and the ToF sensor 220 with each other in accordance with the adjusted modulation frequency value. For example, by synchronizing the ToF sensor 220 and the illuminator 210 with the same modulation frequency value, the processor 120 may identify the phase difference between the light irradiated by the illuminator 210 and the light acquired by the ToF sensor 220.

The processor 120 according to certain embodiments may determine the second power amount to be supplied to the illuminator 210 so that the illuminator 210 can irradiate the light of the second intensity in accordance with the identified distance. For example, if the distance between the electronic device 101 and the object is shorter than a first distance (e.g., close to each other), the processor 120 may supply the second power amount that is smaller than the first power amount to the illuminator 210. As another example, if the distance between the electronic device 101 and the object is equal to or longer than the first distance (e.g., far from each other), the processor 120 may supply the second power amount that is larger than the first power amount to the illuminator 210.

At operation 470, the processor 120 of the electronic device 101 may acquire the depth information for the object based on the adjusted modulation frequency value of the illuminator 210.

For example, the processor 120 may simultaneously measure the distances to the plurality of points on the object based on the phase difference between the light reflected from the object and the light irradiated by the illuminator 210. The processor 120 according to an embodiment may generate the depth image for the object through measurement of the distances to the plurality of points on the object.

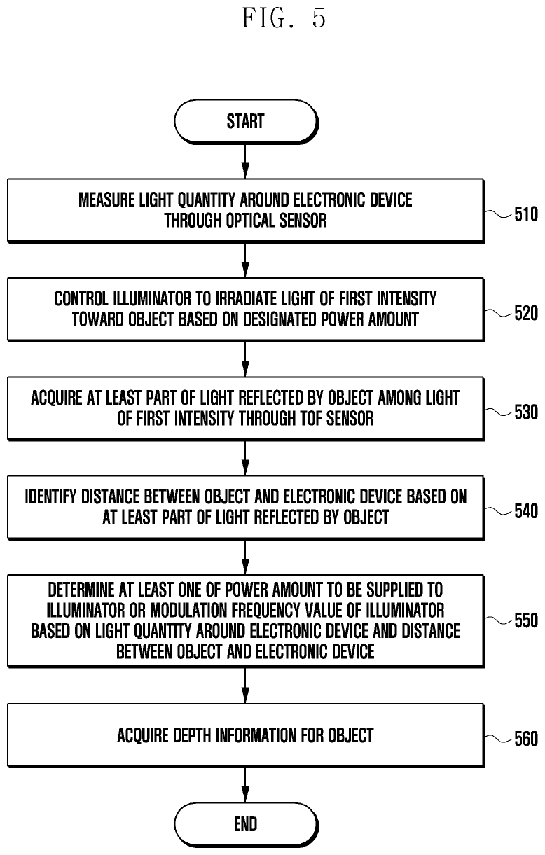

FIG. 5 is a flowchart illustrating a method for acquiring depth information according to certain embodiments of the disclosure.

With reference to FIG. 5, at operation 510, the processor 120 of the electronic device 101 may measure the light quantity in the environment in which the electronic device 101 is disposed through the optical sensor 230.

The processor 120 according to certain embodiments may acquire the illumination value for the environment of the electronic device 101 using the optical sensor 230, and measure the light quantity around the electronic device 101 based on the acquired illumination value. Further, in a certain embodiment, the processor 120 may acquire image data around the electronic device 101 using the optical sensor 230, and it may measure the light quantity of the environment of the electronic device 101 through analysis of the acquired image data.

According to certain embodiments, if a light receiver (e.g., photodiode or image pixel) of the optical sensor 230 changes the acquired light energy to electric energy, the processor 120 may measure the light quantity based on the acquired electric energy. For example, the electric energy may be indicated as a specific level in the range of 0 to 100 levels. The respective levels may correspond to specific light quantities.

At operation 520, the processor 120 of the electronic device 101 may control the illuminator 210 to irradiate the light of the first intensity toward the object based on the designated power amount.

The processor 120 according to certain embodiments may control the illuminator 210 to output the light by applying the power (e.g., driving voltage) to the illuminator 210. For example, the processor 120 may be designated to apply the power of 1 W to the illuminator 210.

The illuminator 210 according to an embodiment may include the driver (e.g., laser diode controller) capable of driving the light source based on a driving signal received from the processor 120. In this case, the processor 120 may be configured to transfer the driving signal corresponding to the power of 1 W to the driver.

At operation 530, the processor 120 of the electronic device 101 may acquire at least a part of the light of the first intensity through the ToF sensor 220, when the light is reflected off the object back towards the ToF sensor 220.

At operation 540, the processor 120 of the electronic device 101 may identify the distance between the object and the electronic device 101 based on at least a part of the light reflected by the object.

According to certain embodiments, the processor 120 may identify the distance between the object and the electronic device 101 through calculation of the time of flight of the difference between the time when the illuminator 210 irradiates the light and the time when the ToF sensor 220 receives the light. The processor 120 according to an embodiment may designate one certain point on the object, and it may determine the distance to the one certain point as the distance between the object and the electronic device 101.

At operation 550, the processor 120 of the electronic device 101 may determine at least one of the power amount to be supplied to the illuminator 210 or the modulation frequency value of the illuminator 210, based on the light quantity in the environment around the electronic device 101, and the distance between the object and the electronic device 101.

The processor 120 according to certain embodiments may determine the first power amount to be supplied to the illuminator 210 based on the light quantity around the electronic device 101 and the distance between the object and the electronic device 101. For example, if the light quantity is smaller than the first threshold value (e.g., if the light quantity is lower than the level 50), the processor 120 may determine to apply the power of 1 W to the illuminator 210. As another example, if the light quantity is equal to or larger than the first threshold value (e.g., if the light quantity exceeds the level 50), the processor 120 may determine to apply the power of 3 W to the illuminator 210.

The processor 120 according to certain embodiments may determine the modulation value of the illuminator 210 based on the light quantity around the electronic device 101 and the distance between the object and the electronic device 101. For example, if the distance between the electronic device 101 and the object satisfies the designated condition (e.g., 3 M or less), the processor 120 may set the modulation frequency to the specific frequency value within 50 MHz to 200 MHz. Further, if the distance between the electronic device 101 and the object does not satisfy the designated condition (e.g., exceeding 3 M), the processor 120 may set the modulation frequency value to the specific frequency value within 25 MHz to 50 MHz.

At operation 560, the processor 120 may acquire the depth information for the object based on the determined power amount to be supplied to the illuminator 210 and/or the modulation frequency value of the illuminator 210.

For example, the processor 120 may simultaneously measure the distances to a plurality of points on the object based on the phase difference between the light reflected from the object and the light irradiated by the illuminator 210. The processor 120 according to an embodiment may generate the depth image for the object through measurement of the distances to the plurality of points on the object.

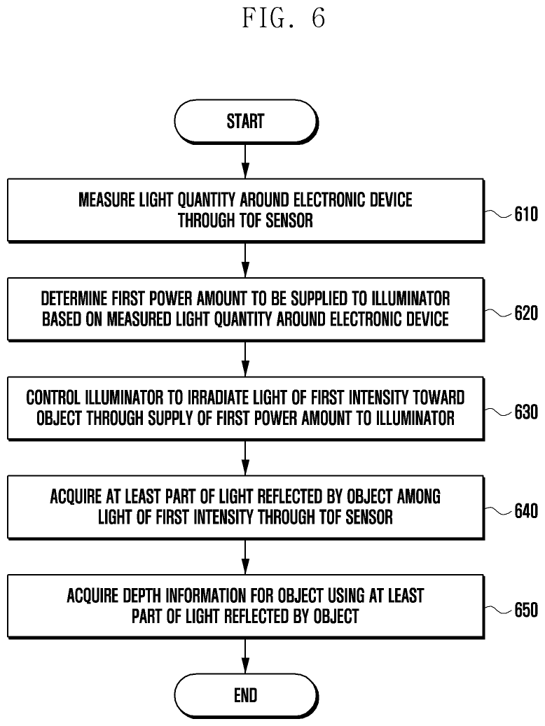

FIG. 6 is a flowchart illustrating a method for acquiring depth information according to certain embodiments of the disclosure.

With reference to FIG. 6, at operation 610, the processor 120 of the electronic device 101 may measure the light quantity of an environment in which the electronic device 101 is disposed, through the ToF sensor 220.

The processor 120 according to certain embodiments may measure the light quantity for the environment of the electronic device 101 using the ToF sensor 220, which is capable of acquiring the light of a first designated wavelength band. The first designated wavelength band may indicate a wavelength band that is invisible to the human eye. For example, it may indicate a wavelength of a near-infrared (NIR) region of 800 nm to 1000 nm. For example, in the room equipped with a fluorescent lamp, the quantity of infrared noise may be minimal, and thus the ToF sensor 220 may sense the low quantity of near-infrared level of light. In contrast, in an exterior environment, infrared noise caused by the sunlight may be high, and thus the ToF sensor 220 may detect the high near-infrared level of light.

According to certain embodiments, if the light energy acquired by the light receiver in the ToF sensor (e.g., photodiode or one pyroelectric detector) is converted into electric energy, the processor 120 may measure the light quantity based on the acquired electric energy. For example, the electric energy may be indicated as a specific level in the range of 0 to 100 levels. The respective levels may correspond to specific infrared light quantities.

At operation 620, the processor 120 of the electronic device 101 may determine the first power amount to be supplied to the illuminator 210 based on the measured light quantity of the environment of the electronic device 101.

The processor 120 according to certain embodiments may control the illuminator 210 to output the light by applying the power (e.g., driving voltage) to the illuminator 210. In accordance with the level of the power being applied by the processor 120, the intensity and/or the wavelength of the light being irradiated by the illuminator 210 may be changed. For example, the processor 120 may differently determine the first power amount to be supplied to the illuminator 210 depending on whether the light quantity around the electronic device 101 satisfies the designated condition. For example, if the light quantity is smaller than the first threshold value (e.g., if the light quantity is lower than the level 50), the processor 120 may determine to apply the power of 1 W to the illuminator 210. As another example, if the light quantity is equal to or larger than the first threshold value (e.g., if the light quantity exceeds the level 50), the processor 120 may determine to apply the power of 3 W to the illuminator 210.

The illuminator 210 according to an embodiment may include the driver (e.g., laser diode controller) capable of driving the light source based on the driving signal received from the processor 120. In this case, the processor 120 may transfer another driving signal to the driver depending on whether the light quantity around the electronic device 101 satisfies the designated condition. For example, if the light quantity satisfies the designated condition (e.g., if the light quantity is lower than the level 50), the processor 120 may transfer the driving signal corresponding to the power of 1 W, whereas if the light quantity does not satisfy the designated condition (e.g., if the light quantity is equal to or higher than the level 50), the processor 120 may transfer the driving voltage corresponding to the power of 3 W to the driver.

The processor 120 according to certain embodiments may determine location information of the electronic device 101 at least partly based on the light quantity around the electronic device 101. For example, the processor 120 may determine whether the electronic device 101 is located indoors or outdoors based on the surrounding brightness level. In this case, the electronic device 101 may identify reliability of the determined location information using at least one other sensor and/or application. For example, the processor 120 may identify the reliability of the location information using the GPS sensor and the map application.

The processor 120 according to certain embodiments may determine the second power amount to be supplied to the illuminator 210 so that the illuminator 210 irradiates light of the second intensity in accordance with the location information of the electronic device 101. For example, in the room where the fluorescent lamp exists, the illumination may be high, but the infrared noise may be low. Accordingly, the processor 120 may supply the second power amount that is smaller than the first power amount to the illuminator 210. In contrast, at the outside, the infrared noise caused by the sunlight may be high, and thus the processor 120 may supply the second power amount that is larger than the first power amount to the illuminator 210.

At operation 630, the processor 120 of the electronic device 101 may control the illuminator 210 to irradiate the light of the first intensity toward the object, through supply of the first power amount to the illuminator 210. The first intensity may correspond to, for example, the first power amount to be supplied from the processor 120.

At operation 640, the processor 120 of the electronic device 101 may acquire the depth information for the object using at least a part of the light reflected by the object.

The processor 120 according to certain embodiments may measure the intensity of the light reflected back towards the ToF sensor 220 from the object, using the ToF sensor 220. The processor 120 may calculate the phase difference between the light reflected from the object and the light irradiated by the illuminator 210 using the intensity of the light measured by the ToF sensor 220.

At operation 650, the processor 120 of the electronic device 101 may acquire the depth information for the object, using at least a part of the light reflected by the object.

For example, the processor 120 may simultaneously measure the distances to the plurality of points on the object based on the phase difference between the light reflected from the object and the light irradiated by the illuminator 210. The processor 120 according to an embodiment may measure the distances to the plurality of points on the object, and it may generate the depth image for the object.

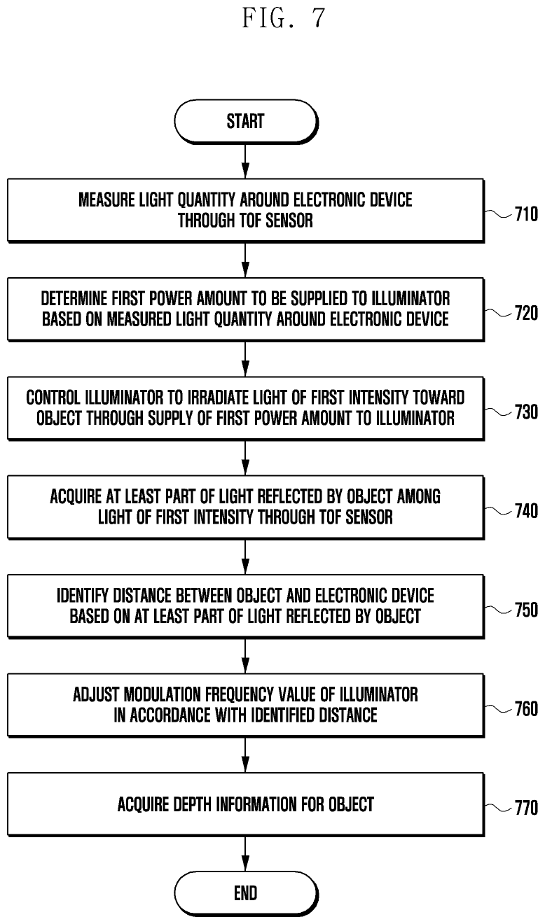

FIG. 7 is a flowchart illustrating a method for acquiring depth information according to certain embodiments of the disclosure.

With reference to FIG. 7, at operation 710, the processor 120 of the electronic device 101 may measure the light quantity around the electronic device 101 through the ToF sensor 220.

The processor 120 according to certain embodiments may measure the light quantity for an environment in which the electronic device 101 is disposed using the ToF sensor 220, which is capable of acquiring a light of the first designated wavelength band. The first designated wavelength band may indicate a wavelength band that is invisible to the human eye, for example, it may indicate a wavelength of a near-infrared (NIR) region of 800 nm to 1000 nm. For example, in the room where a fluorescent lamp exists, the infrared noise may be low, and thus the ToF sensor 220 may detect the low near-infrared level. In contrast, at the outside, infrared noise caused by the sunlight may be high, and thus the ToF sensor 220 may detect the high near-infrared level.

According to certain embodiments, if the light energy acquired by the light receiver in the ToF sensor (e.g., photodiode or one pyroelectric detector) is converted into electric energy, the processor 120 may measure the light quantity based on the acquired electric energy. For example, the electric energy may be indicated as a specific level in the range of 0 to 100 levels. The respective levels may correspond to specific infrared light quantities.

At operation 720, the processor 120 of the electronic device 101 may determine the first power amount to be supplied to the illuminator 210 based on the measured light quantity around the electronic device 101.

At operation 730, the processor 120 of the electronic device 101 may control the illuminator 210 to irradiate the light of the first intensity toward the object, through supply of the first power amount to the illuminator 210. The first intensity may correspond to, for example, the first power amount to be supplied from the processor 120.

At operation 740, the processor 120 of the electronic device 101 may acquire at least a part of the light of the first intensity when it is reflected off the object and back towards the ToF sensor 220, as to be detected through the ToF sensor 220.

At operation 750, the processor 120 of the electronic device 101 may identify the distance between the object and the electronic device 101 based on at least a part the light reflected by the object.

According to certain embodiments, the processor 120 may identify the distance between the object and the electronic device 101 by calculation of the time of flight which is the difference between a first time when the illuminator 210 irradiates the light, and a second time when the ToF sensor 220 receives the light. The processor 120 according to an embodiment may designate one certain point on the object, and it may determine the distance to the one certain point as the distance between the object and the electronic device 101. This is to identify the rough distance between the electronic device 101 and the object before the depth image for the object is acquired.

At operation 760, the processor 120 of the electronic device 101 may adjust the modulation frequency value of the illuminator 210 in accordance with the identified distance.

The illuminator 210 according to certain embodiments may output the modulated light for modulating the light in the high frequency pulse shape in accordance with the designated modulation frequency value. For example, the illuminator 210 may irradiate lights having phases of 0°, 90°, 180°, and 270° onto the object. In this case, the illuminator 210 may be shown to output the light including a pattern of blinking at designated intervals.

The processor 120 according to certain embodiments may set another modulation value depending on whether the distance between the electronic device 101 and the object satisfies the designated condition. For example, if the distance between the electronic device 101 and the object satisfies the designated condition (e.g., less than 3 M), the processor 120 may set the modulation frequency to the specific frequency value within 50 MHz to 200 MHz. Further, if the distance between the electronic device 101 and the object does not satisfy the designated condition (e.g., equal to or larger than 3 M), the processor 120 may set the modulation frequency to the specific frequency value within 25 MHz to 50 MHz.

The processor 120 according to certain embodiments may synchronize the illuminator 210 and the ToF sensor 220 with each other in accordance with the adjusted modulation frequency value. For example, by synchronizing the ToF sensor 220 and the illuminator 210 with the same modulation frequency value, the processor 120 may identify the phase difference between the light irradiated by the illuminator 210 and the light acquired by the ToF sensor 220.

The processor 120 according to certain embodiments may determine the second power amount to be supplied to the illuminator 210 so that the illuminator 210 can irradiate the light of the second intensity in accordance with the identified distance. For example, if the distance between the electronic device 101 and the object is shorter than the first distance (e.g., close to each other), the processor 120 may supply the second power amount that is smaller than the first power amount to the illuminator 210. As another example, if the distance between the electronic device 101 and the object is equal to or longer than the first distance (e.g., far from each other), the processor 120 may supply the second power amount that is larger than the first power amount to the illuminator 210.

At operation 770, the processor 120 of the electronic device 101 may acquire the depth information for the object based on the adjusted modulation frequency value of the illuminator 210.

For example, the processor 120 may simultaneously measure the distances to the plurality of points on the object based on the phase difference between the light reflected from the object and the light irradiated by the illuminator 210. The processor 120 according to an embodiment may generate the depth image for the object through measurement of the distances to the plurality of points on the object.

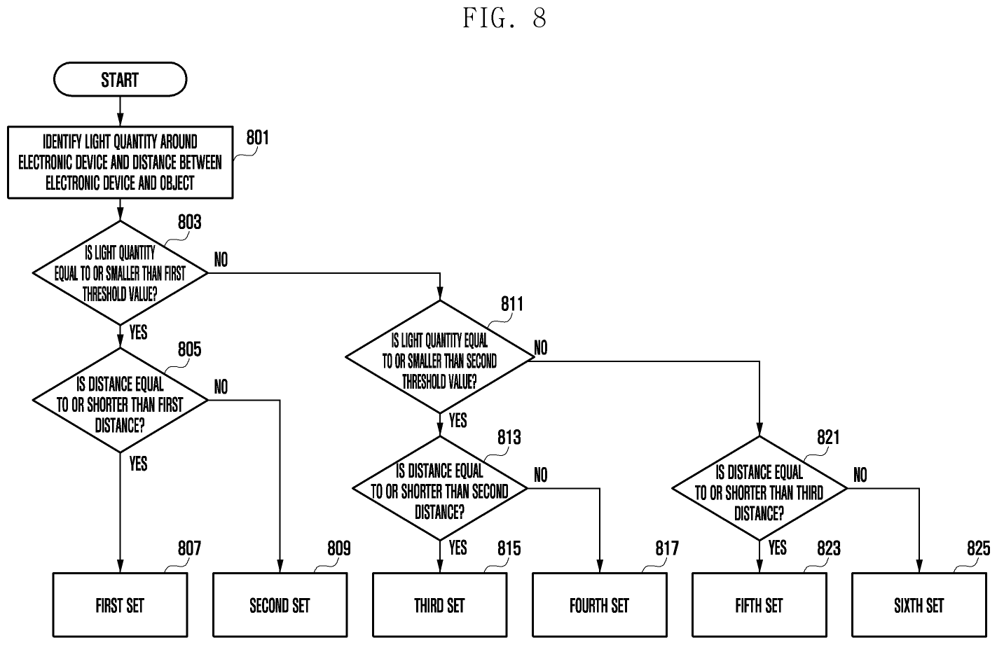

FIG. 8 is a diagram illustrating an example of adjusting a set value based on a surrounding environmental condition of an electronic device 101 according to an embodiment of the disclosure.

With reference to FIG. 8, at operation 801, the processor 120 of the electronic device 101 may identify the light quantity for an environment in which the electronic device 101 is disposed, and the distance between the electronic device 101 and the object. For example, the processor 120 may measure the light quantity around the electronic device 101, or identify the distance between the electronic device 101 and the object using at least one of the methods illustrated in FIGS. 3 to 7.

At operation 803, the processor 120 of the electronic device 101 may identify whether the light quantity around the electronic device 101 is equal to or smaller than the first threshold value. Here, the first threshold value may be a value designated by the user or the depth information acquisition system. For example, the first threshold value may correspond to the light quantity of the level 50.

If the light quantity is equal to or smaller than the first threshold value, the processor 120 of the electronic device 101, at operation 805, may identify whether the distance between the electronic device 101 and the object is equal to or shorter than the first distance. Here, the first distance may be a value designated by the user or the depth information acquisition system. For example, the first distance may correspond to 3 M.

If the distance between the electronic device 101 and the object is equal to or shorter than the first distance, the processor 120 of the electronic device 101, at operation 807, may set the electronic device 101 to a first set value. The first set value may be, for example, a value whereby the power of 1 W is applied to the illuminator 210 and the modulation frequency of the illuminator 210 is set to a specific frequency value within 50 MHz to 200 MHz.

Again at operation 805, if the distance between the electronic device 101 and the object exceeds the first distance, the processor 120 of the electronic device 101, at operation 809, may set the electronic device 101 to a second set value. The second set value may be, for example, a value whereby the power of 2 W is applied to the illuminator 210 and the modulation frequency of the illuminator 210 is set to a specific frequency value within 25 MHz to 50 MHz.

Again at operation 803, if the light quantity exceeds the first threshold value, the processor 120 of the electronic device 101, at operation 811, may identify whether the light quantity around the electronic device 101 is equal to or smaller than the second threshold value. Here, the first threshold value is a value designated by the user or the depth information acquisition system, and it may be at least larger than the second threshold value. For example, the second threshold value may correspond to the light quantity of the level 70.

If the light quantity is equal to or smaller than the second threshold value, the processor 120 of the electronic device 101, at operation 813, may identify whether the distance between the electronic device 101 and the object is equal to or shorter than the second distance. Here, the second distance may be a value designated by the user or the depth information acquisition system, and it may be equal to or different from the first distance. For example, the second distance may correspond to 3 M or 2 M.

If the distance between the electronic device 101 and the object is equal to or shorter than the second distance, the processor 120 of the electronic device 101, at operation 815, may set the electronic device 101 to a third set value. The third set value may be, for example, a value whereby the power of 3 W is applied to the illuminator 210 and the modulation frequency of the illuminator 210 is set to a specific frequency value within 50 MHz to 100 MHz.

Again at operation 813, if the distance between the electronic device 101 and the object exceeds the second distance, the processor 120 of the electronic device 101, at operation 817, may set the electronic device 101 to a fourth set value. The fourth set value may be, for example, a value whereby the power of 4 W is applied to the illuminator 210 and the modulation frequency of the illuminator 210 is set to a specific frequency value within 25 MHz to 50 MHz.

Again at operation 811, if the light quantity exceeds the second threshold value, the processor 120 of the electronic device 101, at operation 821, may identify whether the distance between the electronic device 101 and the object is equal to or shorter than the third distance. Here, the third distance may be a value designated by the user or the depth information acquisition system, and it may be equal to or different from the first or second distance. For example, the third distance may correspond to 1 M, 2 M, or 3 M.

If the distance between the electronic device 101 and the object is equal to or shorter than the third distance, the processor 120 of the electronic device 101, at operation 823, may set the electronic device 101 to a fifth set value. The fifth set value may be, for example, a value whereby the power of 5 W is applied to the illuminator 210 and the modulation frequency of the illuminator 210 is set to a specific frequency value within 50 MHz to 100 MHz.

Again at operation 821, if the distance between the electronic device 101 and the object exceeds the third distance, the processor 120 of the electronic device 101, at operation 825, may set the electronic device 101 to a sixth set value. The sixth set value may be, for example, a value whereby the power of 6 W is applied to the illuminator 210 and the modulation frequency of the illuminator 210 is set to a specific frequency value within 25 MHz to 50 MHz.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
an illuminator configured to output light of a first designated wavelength band;
a time of flight (ToF) sensor configured to acquire the light of the first designated wavelength band;
an optical sensor configured to acquire light of a second designated wavelength band; and
a processor, configured to:
measure, through the optical sensor, a light quantity of an environment in which the electronic device is disposed,
determine a first power amount to be supplied to the illuminator, based on the measured light quantity,
control the illuminator to irradiate light of a first intensity toward an object, using a supply of power to the illuminator at the first power amount,
detect, by the ToF sensor, at least a part of the irradiated light, when reflected off the object and back towards the electronic device, and
generate depth information for the object using the at least the part of the detected irradiated light reflected off the object.

2. The electronic device of claim 1, wherein the processor is further configured to:
detect a distance between the object and the electronic device based at least on the part of the light reflected by the object, and
adjust a modulation frequency of the illuminator based on the detected distance.

3. The electronic device of claim 2, wherein the processor is further configured to synchronize the illuminator and the ToF sensor based on the adjusted modulation frequency.

4. The electronic device of claim 2, wherein the processor is further configured to determine a second power amount to be supplied to the illuminator, to cause the illuminator to irradiate light of a second intensity based on the detected distance.

5. The electronic device of claim 1, wherein the processor is further configured to determine location information of the electronic device based on at least the measured light quantity of the environment.

6. The electronic device of claim 5, wherein the processor is further configured to determine a second power amount to supply to the illuminator to cause the illuminator to irradiate light of a second intensity, based on the determined location information of the electronic device.

7. The electronic device of claim 1, wherein the processor is further configured to:
compare the measured light quantity of the environment with a first threshold value, and
determine the first power amount based on a result of the comparison.

8. An electronic device, comprising:
an illuminator configured to output light of a first designated wavelength band;
a time of flight (ToF) sensor configured to acquire the light of the first designated wavelength band;
an optical sensor configured to acquire light of a second designated wavelength band; and
a processor, configured to:
measure, through the optical sensor, a light quantity for an environment in which the electronic device is disposed,
control the illuminator to irradiate light of a first intensity toward an object based on a designated power amount determined based on the measured light quantity,
acquire at least a part of the irradiated light after the irradiated light is reflected by the object back towards the electronic device through the ToF sensor,
identify a distance between the object and the electronic device based at least on the acquired part of the irradiated light,
determine at least one of a power amount to supply to the illuminator, and a modulation frequency of the illuminator, based on the light quantity of the environment and the identified distance between the object and the electronic device, and
acquire depth information for the object.

9. The electronic device of claim 8, wherein the processor is further configured to synchronize the illuminator and the ToF sensor based on the adjusted modulation frequency.

10. The electronic device of claim 8, wherein the processor is further configured to determine a location of the electronic device based on at least the measured light quantity of the environment.

11. The electronic device of claim 10, wherein the processor is further configured to determine at least one of the power amount to be supplied to the illuminator and the modulation frequency of the illuminator, based at least in part on the determined location.

12. The electronic device of claim 8, wherein the processor is further configured to:
compare the measured light quantity of the environment with a designated first threshold value, and
determine the power amount to be supplied to the illuminator based on a result of the comparison.

13. The electronic device of claim 8, wherein the processor is further configured to:
compare the distance between the object and the electronic device, with a designated first distance, and
determine the modulation frequency of the illuminator based on a result of the comparison.

14. An electronic device, comprising:
an illuminator configured to output light of a first designated wavelength band;
a time of flight (ToF) sensor configured to acquire the light of the first designated wavelength band; and
a processor, configured to:
measure a light quantity of an environment in which the electronic device is disposed through the ToF sensor,
determine a first power amount to be supplied to the illuminator based on the measured light quantity,
control the illuminator to irradiate light of a first intensity toward an object using a supply of power to the illuminator at the first power amount,
acquire at least a part of the irradiated light when reflected by the object back towards the electronic device through the ToF sensor, and
acquire depth information for the object using the acquired part of the irradiated light.

15. The electronic device of claim 14, wherein the processor is further configured to:
identify a distance between the object and the electronic device based on the acquired part of the irradiated light reflected by the object, and
adjust a modulation frequency of the illuminator in accordance with the identified distance.

16. The electronic device of claim 15, wherein the processor is further configured to synchronize the illuminator and the ToF sensor based on the adjusted modulation frequency.

17. The electronic device of claim 15, wherein the processor is further configured to determine a second power amount to supply to the illuminator to cause the illuminator to irradiate light of a second intensity based on the identified distance.

18. The electronic device of claim 14, wherein the processor is further configured to determine location information of the electronic device based on at least on the measured light quantity of the environment.

19. The electronic device of claim 18, wherein the processor is further configured to determine a second power amount to supply to the illuminator to cause the illuminator to irradiate light of a second intensity based on the location information of the electronic device.

20. The electronic device of claim 14, wherein the processor is further configured to:
compare the measured light quantity of the environment with a first threshold value, and
determine the first power amount based on a result of the comparison.
